(19) United States
(12) Patent Application Publication
(10) Pub. No.: US 2026/0039691 A1
(43) Pub. Date: Feb. 5, 2026

(54) CLIENT-SIDE ANTI-PHISHING SYSTEMS AND METHODS

(71) Applicant: OPEN TEXT HOLDINGS, INC., Menlo Park, CA (US)

(72) Inventors: Sachin Pargi, Bangalore (IN); Hemanth Moganna Gowda, Bengaluru (IN)

(21) Appl. No.: 18/788,562

(22) Filed: Jul. 30, 2024

(51) Int. Cl. H04L 9/40

(52) U.S. Cl. CPC H04L 63/1483

(57) ABSTRACT

A client-side anti-phishing solution provides an anti-phishing browser plug-in and an anti-phishing module on a user device for initiating an anti-phishing operation on the user device as a user enters a login credential on a web page originating from a website. The anti-phishing operation comprises generating a random number of phishing credentials based on the login credential, randomly selecting, from the random number of phishing credentials, a phishing credential, and causing a browser application on the user device to submit the phishing credential to the website on behalf of the user. Depending upon whether the phishing credential is accepted by the website, access to the website is blocked or allowed. Since the client-side anti-phishing solution does not need to rely on complex machine learning models to classify unknown websites, active phishing websites can be quickly and effectively blocked from procuring user credentials before submission.

### TECHNICAL FIELD

This disclosure relates generally to network security. More particularly, this disclosure relates to client-side anti-phishing systems, methods, and computer program products for protecting users from phishing websites on the Internet.

### BACKGROUND OF THE RELATED ART

Today, there are more than 1 billion websites on the Internet. Of these, hundreds of millions of websites are actively updated and visited. Unfortunately, not all of them are legitimate websites as some are designed to steal user login credentials. Such malicious websites are commonly referred to as spoofed websites or phishing websites. A login credential refers to a set of unique identifiers (IDs), such as a username and password, that enables a user to verify identity in order to log in to an online account.

Usually, a scammer sends a target user an email or a message that spoofs a trusted source, such as a legitimate website, trying to trick the target user into clicking on a malicious link that takes the target user to a phishing website. Because the phishing website may look similar in name and/or appearance to the legitimate website, the target user may proceed to log into the phishing website and, in doing so, provide their login credential to the phishing website.

Increasingly, quick adaptations of scammers in hiding and layering phishing techniques are forcing network security service providers to retrain phish detection machine learning (ML) models used in classifying and detecting phishing websites. This process, however, can take time, e.g., between six months to a year, due to the amount of data that must be collected, processed, and then used to retrain and test each phish detection ML model.

Further, unlike many classification problems that trade-off between false negatives and false positives, current phish detection ML models are under stress to perform at incredibly high accuracy to avoid both. However, as those skilled in the art can appreciate, it is extremely difficult to determine at what point the cost of false positives would overcome the damage from false negatives.

This problem is exacerbated due to the highly imbalanced nature of legitimate/benign websites versus phishing websites, as only a negligible percentage of billions of webpages on the internet actually belong to phishing websites. The complexities of webpage contents, changing standards, short lives of phishing websites, etc. all contribute to a continuing need to protect users from phishing websites on the Internet.

### SUMMARY OF THE DISCLOSURE

A goal of this disclosure is to provide a client-side anti-phishing solution that can augment the current anti-phishing processes, including those relying on classifier ML models. In this disclosure, true positives refer to phish/malicious websites that are detected/recognized as such; true negatives refer to good/benign websites that are recognized as such; false positives (Type I errors) refer to good/benign websites that are misclassified/misrecognized as phish/malicious; and false negatives (Type II errors) refer to phish/malicious websites that are misclassified/misrecognized as good/benign.

The client-side anti-phishing solution disclosed herein can trick a phishing website at the cost of one failed login. This technique is referred to herein as “Bait-n-Switch.” In doing so, a significant number of false negatives and false positives (i.e., Type I errors and Type II errors) can be reduced, alleviating the pressure on depending only on classifier ML models.

In some embodiments, the client-side anti-phishing solution is implemented on a user device having a processor, a non-transitory computer-readable medium, and instructions stored on the non-transitory computer-readable medium and translatable by the processor for implementing an anti-phishing browser plug-in and an anti-phishing module on the user device. The anti-phishing browser plug-in and the anti-phishing module work collaboratively to initiate an anti-phishing operation on the user device as a user enters a login credential on a web page originating from a website.

In some embodiments, the phishing browser plug-in may receive, through a browser application on the user device, an indication that the user is entering the login credential on the web page. In response, the phishing browser plug-in may capture user inputs including the login credential being entered on the webpage. The phishing browser plug-in may call the anti-phishing module to determine whether the web page comes from a good website, a bad website, or an unknown website. In some embodiments, the anti-phishing module may maintain internal databases, such as an offenders database and a registration database, to keep track of good websites, bad websites, new websites, and user credentials.

The offenders database may store a plurality of universal resource locators (URLs), each respective URL of the plurality of URLs having a phishing status indicative of whether the respective URL is a good URL, a phishing URL, or a new URL. The anti-phishing module may perform a lookup operation over the offenders database to determine whether the web page comes from a good website, a phishing website, or an unknown website.

Responsive to not finding the web page in the offenders database, the anti-phishing module may parse the user input to obtain the login credential, perform a lookup operation on the login credential over the registration database, and responsive to finding the login credential in the registration database, set a phishing status to indicate that the web page comes from a new website and also set a credential status to indicate that the login credential is true. Responsive to the phishing status being set to new and the credential status being set to true, the anti-phishing module may proceed to perform the anti-phishing operation on the user device.

In some embodiments, the anti-phishing operation comprises generating a random number of phishing credentials based on the login credential, randomly selecting, from the random number of phishing credentials, a phishing credential, and causing the browser application on the user device to submit the phishing credential to the website on behalf of the user. Depending upon whether the phishing credential is accepted by the website, access to the website is blocked or allowed. The anti-phishing module may then update the offenders database to reflect whether the website passed or failed the anti-phishing operation.

In some embodiments, responsive to the phishing credential being accepted by the website, the phishing browser plug-in may generate a message for display by the browser application. The message indicates that the website has failed the phishing operation and, therefore, access to the website is to be blocked.

In some embodiments, responsive to the phishing credential being rejected by the website, the phishing browser plug-in may generate a message for display by the browser application. The message indicates that the website has passed the phishing operation and, therefore, access to the website is allowed and the user can proceed to log in to the website (e.g., by re-entering the user's login credential).

Since the client-side anti-phishing solution does not need to rely on complex phish detection ML models to classify unknown websites, active phishing websites can be quickly and effectively blocked from procuring user credentials before submission. This augments current phish detection processes and alleviates the pressure of having to depend only on phish detection ML models, which can take an extensive period of time and a massive amount of data to develop, test, and deploy.

One embodiment comprises a system comprising a processor and a non-transitory computer-readable storage medium that stores computer instructions translatable by the processor to perform a method substantially as described herein. Another embodiment comprises a computer program product having a non-transitory computer-readable storage medium that stores computer instructions translatable by a processor to perform a method substantially as described herein. Numerous other embodiments are also possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, and/or rearrangements may be made within the scope of the disclosure without departing from the spirit thereof, and the disclosure includes all such substitutions, modifications, additions, and/or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 depicts a diagrammatic representation of an example of an enterprise computer network in which network communications between an enterprise user and websites on the Internet are monitored and protected by an Internet security system running on a server machine.

FIG. 2 is a flow chart that illustrates an example of a client-side anti-phishing process according to some embodiments disclosed herein.

FIG. 3 depicts a diagrammatic representation of a networked computing environment having a user device implementing the client-side anti-phishing process of FIG. 2, according to some embodiments disclosed herein.

FIG. 4 shows example operations performed by an anti-phishing browser plug-in and a client-side anti-phishing module on a user device according to some embodiments disclosed herein.

FIG. 5 illustrates another embodiment of an anti-phishing browser plug-in and a client-side anti-phishing module configured for performing an anti-phishing process on a user device.

FIG. 6 depicts a diagrammatic representation of a data processing system for implementing a method according to some embodiments disclosed herein.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

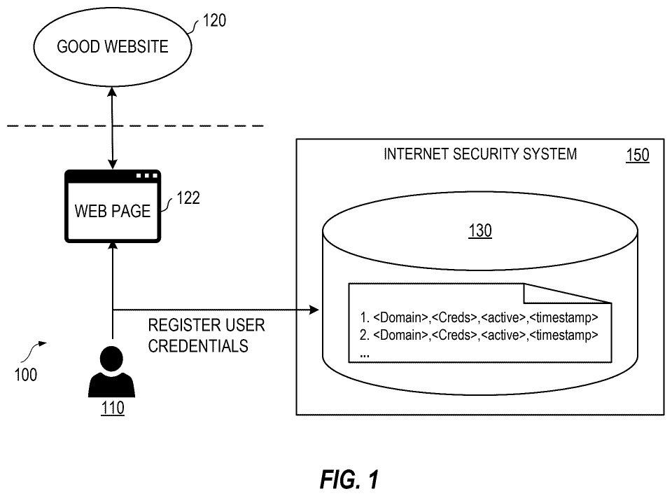

FIG. 1 depicts an enterprise computer network 100 in which network communications between an enterprise user 110 and websites on the Internet are monitored and protected by an Internet security system 150 running on a server machine (which may run on the premises of the enterprise computer network 100 or operate in a cloud computing environment so as to provide Internet security services to devices on the enterprise computer network 100). Often equipped with various network security technologies (not shown), the Internet security system 150 is capable of identifying legitimate or benign (i.e., non-threating) websites, which are collectively referred to herein as “good” websites. This can be done by keeping a whitelist or database containing information on good websites. When the enterprise user 110 attempts to access a web page at a network address (e.g., a universal resource locator or URL) of a web server, the Internet security system 150 is operable to look up the URL against the whitelist or database and inform the enterprise user 110 accordingly.

In some cases, the enterprise user 110 may wish to register with a good website 120 through a web page 122 displayed within a browser application on a client device associated with the enterprise user 110. When the enterprise user enters their login credential (e.g., a user ID and password), an agent or plug-in on the client device captures and sends the login credential to the Internet security system 150 over a secure network connection. The Internet security system 150, in turn, stores the user-provided login credential in an encrypted registration database 130, as illustrated in FIG. 1.

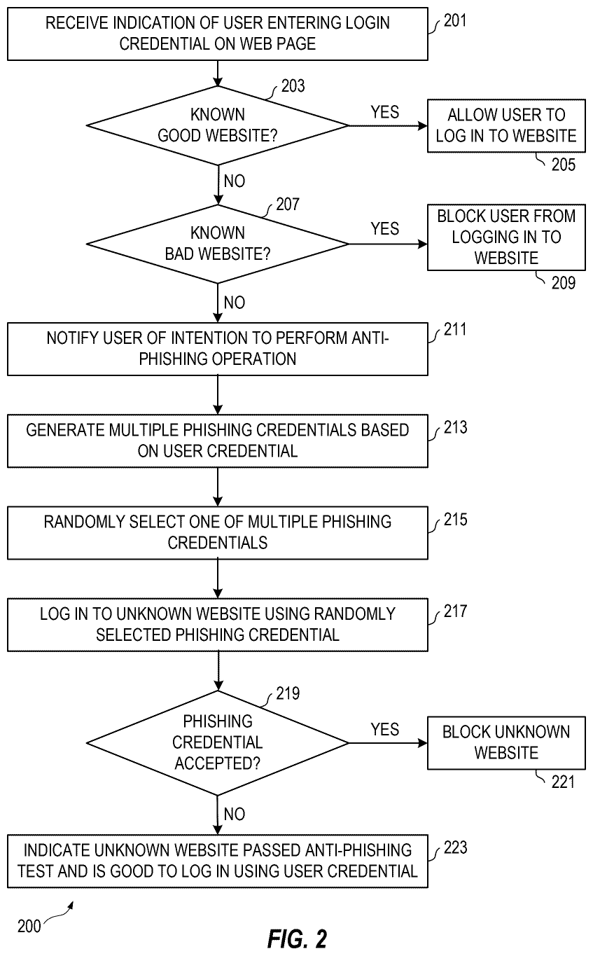

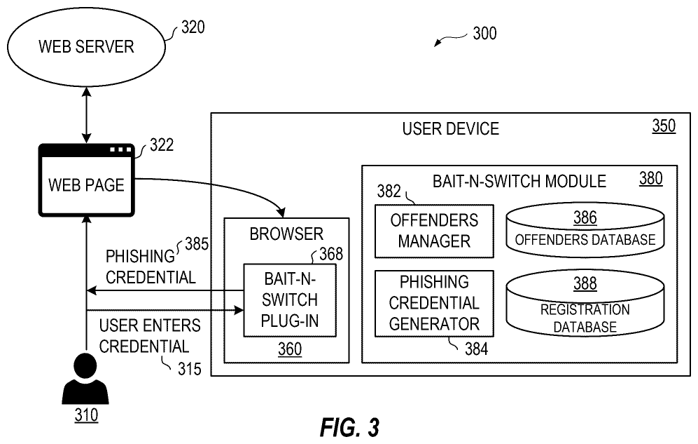

Embodiments of a client-side anti-phishing solution disclosed herein can augment anti-phishing operations performed by server-based Internet security systems such as the Internet security system 150 shown in FIG. 1. FIG. 2 is a flow chart that illustrates an example of a client-side anti-phishing process 200. FIG. 3 depicts a diagrammatical representation of a networked computing environment 300 where a user device 350 operates. In the example of FIG. 3, the user device 350 has an anti-phishing browser plug-in (e.g., a Bait-n-Switch plug-in 368) and a client-side anti-phishing module (e.g., a Bait-n-Switch module 380) that work in concert to implement the client-side anti-phishing process 200.

In some embodiments, the anti-phishing browser plug-in may receive, through a browser application (e.g., a browser 360), an indication that a user (e.g., an enterprise user 310) has entered a login credential (which includes a set of IDs such as a user ID and password) into input fields of a web page (e.g., a web page 322) hosted by a web server (e.g., a web server 320) at a URL (201). Responsive to the indication, the anti-phishing browser plug-in is operable to intercept the login credential so that the login credential is not sent to the web server through the web page. Rather, the anti-phishing browser plug-in sends (e.g., via an application programming interface (API) call) a request for information about the web page and/or the web server to the client-side anti-phishing module. The request may include the URL where the web page resides and/or a domain where the web server resides. The request may further include the login credential provided by the user.

While examples disclosed herein focus on a client-side anti-phishing solution, those skilled in the art appreciate that, in other embodiments, features disclosed herein can be implemented in a client-server anti-phishing solution. For example, the request from the anti-phishing browser plug-in may also include content of the web page (which can be captured via the web page source code). An anti-phishing module on a user device may make an API call to a larger program, such as an anti-phishing system, an Internet security system, etc., that operates on a server machine to perform a passive verification using the content of the web page. The passive verification may leverage a large language model (LLM) or some machine learning (ML) models to classify or otherwise determine whether the web page comes from a good website or a bad website. The anti-phishing module may receive a result of the passive verification from the server side and causes the browser, through an anti-phishing browser plug-in, to allow (if the web page is determined as coming from a good website) the user to log in to the website through the web page or to block (if the web page is determined as coming from a bad website) the website from getting the user's login credential through the web page.

In some embodiments, the client-side anti-phishing solution is standalone and operates entirely on a user device. In such cases, the client-side anti-phishing module includes internal databases that keep track of bad/phishing websites, domains, and/or URLs (e.g., in an encrypted offenders database 386) and good/registered websites, domains, and/or URLs (e.g., in an encrypted registration database 388). As further described below, responsive to a request from the anti-phishing browser plug-in, the client-side anti-phishing module is operable to check the internal database and return an appropriate message.

For example, the client-side anti-phishing module may query a registration database about a domain contained in the request (203). If the domain is found in the registration database, the client-side anti-phishing module determines that the web page belongs to a known good website and indicates to the anti-phishing browser plug-in to allow the user to proceed and log in to the known good website through the web page (205). If the domain is not found in the registration database, the client-side anti-phishing module may perform a lookup operation to look up the URL in an offenders database (207). If the URL is found in the offenders database, the client-side anti-phishing module determines that the web page belongs to a known bad website and indicates to the anti-phishing browser plug-in to block the user from proceeding further so that the known bad website cannot procure the user's login credential (209).

In some cases, the client-side anti-phishing module may not be able to verify whether the web page belongs a known good website or a known bad website. That is, the web page belongs to an unknown website (i.e., the web site is unknown to the client-side anti-phishing module on the user device). In such a case, the client-side anti-phishing module initiates an anti-phishing operation and informs the anti-phishing browser plug-in accordingly. In response, the anti-phishing browser plug-in is operable to notify the user that, because the web page is unknown, an anti-phishing operation is to be performed to verify whether the web page belongs to a phishing website (211). In one embodiment, the anti-phishing browser plug-in may do so while allowing the browser application to load a minimum amount of content of the website (e.g., without input fields).

Meanwhile, the client-side anti-phishing module is operable to generate multiple dummy credentials based on the login credential provided by the user (213). These dummy credentials are referred to herein as “phishing credentials.” From the multiple phishing credentials, the client-side anti-phishing module randomly selects a phishing credential (215) and causes the browser application (through the anti-phishing browser plug-in) to submit the randomly selected phishing credential to the unknown website through the web page as if the user is logging in to the unknown website (217).

The client-side anti-phishing module may take appropriate actions depending upon whether the randomly selected phishing credential is accepted by the unknown website (219). For example, if the randomly selected phishing credential is accepted by the unknown website, the client-side anti-phishing module may cause the browser application (through the anti-phishing browser plug-in) to block the unknown website so that no user input can be received by the unknown website (221). In some embodiments, the client-side anti-phishing module may take further actions such as notifying the user that the unknown website is actually a phishing website, notifying a network security service and/or an administrator about finding a phishing website, updating the offenders database, etc. If the randomly selected phishing credential is rejected by the unknown website (which means that the unknown website keeps track of its registered users with respective login credentials), the client-side anti-phishing module may cause the browser application (through the anti-phishing browser plug-in) to indicate to the user that the unknown website passed the phishing test and the user is good to proceed to log in to the website through the web page (223).

Referring to FIG. 3, in some embodiments, the Bait-n-Switch plug-in 368 may implement the anti-phishing browser plug-in described above and the Bait-n-Switch module 380 may implement the client-side anti-phishing module described above. As illustrated in FIG. 3, the Bait-n-Switch module 380 may include an offenders manager 382, a phishing credential generator 384, the offenders database 386, and the registration database 388. The offenders manager 382 is operable to communicate with the Bait-n-Switch plug-in 368, which runs as an extension of the browser 360.

When the enterprise user 310 enters their login credential 315 into input fields of the web page 322, the login credential 315 is captured (and, in some cases, along with the URL and web page content) by the anti-phishing browser plug-in 368. The anti-phishing browser plug-in 368 calls the offenders manager 382 with the captured information. The offenders manager 382 queries the offenders database 386 and the registration database 388 and determines whether the web page belongs to a good website, a bad website, or an unknown website. If the web page belongs to an unknown website, the offenders manager 382 initiates an anti-phishing operation and notifies the Bait-n-Switch plug-in 368 which, in turn, notifies the enterprise user 310 through a message displayed on the user device 350.

In one embodiment, the Bait-n-Switch plug-in 368 may allow the browser 360 to load a minimum amount of content of the web page 322 from the web server 320. Meanwhile, as part of the anti-phishing operation, the offenders manager 382 is operable to cause the phishing credential generator 384 to generate multiple phishing credentials based on the login credential of the enterprise user 310. The offenders manager 382 then randomly selects, from the multiple phishing credentials thus generated, a phishing credential 385 and returns it to the Bait-n-Switch plug-in 368. The Bait-n-Switch plug-in 368 is operable to submit, through the browser 360, the phishing credential 385 to the web server 320 through the web page 322 on behalf of the enterprise user 310.

If the phishing credential 385 is accepted, this acceptance is communicated to the Bait-n-Switch plug-in 368 (through the Bait-n-Switch plug-in 368) and the web page 322 is determined by the Bait-n-Switch plug-in 368 as coming from a phishing website. If the phishing credential 385 is rejected, this rejection is communicated to the Bait-n-Switch plug-in 368 (through the Bait-n-Switch plug-in 368) and the web page 322 is determined by the Bait-n-Switch plug-in 368 as a good website.

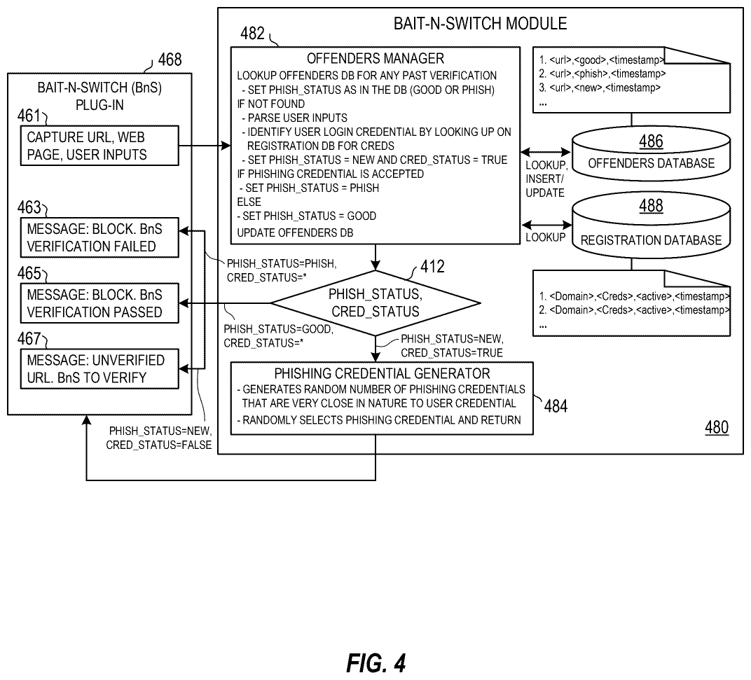

FIG. 4 shows example operations performed by a Bait-n-Switch plug-in 468 and a client-side Bait-n-Switch module 480 on a user device. As illustrated in FIG. 4, the Bait-n-Switch plug-in 468 is operable to perform a first operation 461 to capture an URL of a web page (e.g., the web page 322) of a website hosted on a web server (e.g., the web server 320), as well as content of the web page and user inputs such as a login credential entered by the user. The Bait-n-Switch plug-in 468 communicates the captured information to an offenders manager 482 (e.g., via an API call).

The offenders manager 482, in turn, look up an offenders database (DB) 486 for any past verification of the URL and, if the URL is found, set a phishing status (“phish_status”) as indicated in the an offenders DB 486. In some embodiments, the offenders DB 486 may store a plurality of URLs, each of which has a phishing status of “good,” “phish,” or “new,” and has a timestamp indicating when the URL is last entered or updated.

If the URL is not found in the offenders database (DB) 486, the offenders manager 482 may parse the user inputs captured by the Bait-n-Switch plug-in 468 to identify a login credential. This may entail performing a lookup operation over the registration DB 488. If the login credential is not found in the registration DB 488, the offenders manager 482 may set the phishing status associated with the URL as “new” and set a credential status (“cred_status”) as “false” and communicates the phishing status and the credential status to the Bait-n-Switch plug-in 468 (through a decision logic 412, as shown in FIG. 4). The Bait-n-Switch plug-in 468, in turn, may generate a message 467 for display by the browser to notify the user that the web page comes from an unverified website and, therefore, an anti-phishing operation is to be performed to verify whether the website is or is not a phishing website.

To perform the anti-phishing operation, the offenders manager 482 sets the credential status as “true” and communicates the phishing status (“new”) and the credential status (“true”) to the decision logic 412. The decision logic 412 is operable to determine, if the phishing status is “new” and the credential status is “true,” then a phishing credential generator 484 is called. In some embodiments, the decision logic 412 can be implemented as part of the offenders manager 482.

The phishing credential generator 484, in turn, generates a random number of phishing credentials (each of which consists of a set of unique IDs) that are very close in nature to the login credential provided by the user and captured by the Bait-n-Switch plug-in 468. The phishing credential generator 484 then randomly selects, from the number of phishing credentials thus generated, a phishing credential and returns the randomly selected phishing credential to the Bait-n-Switch plug-in 468. The Bait-n-Switch plug-in 468, in turn, causes the browser to submit the randomly selected phishing credential to the web page on behalf of the user.

If the randomly selected phishing credential is accepted, the acceptance is communicated to the offenders manager 482 through the Bait-n-Switch plug-in 468 and the offenders manager 482 sets the phishing status to “phish” and updates the offenders DB 486 accordingly. Meanwhile, the Bait-n-Switch plug-in 468 generates a message 463 for display by the browser to notify the user that the website has failed the phishing test and, therefore, further access to the website is blocked.

If the randomly selected phishing credential is rejected, the rejection is communicated to the offenders manager 482 through the Bait-n-Switch plug-in 468 and the offenders manager 482 sets the phishing status to “good” and updates the offenders DB 486 accordingly. Meanwhile, the Bait-n-Switch plug-in 468 generates a message 465 for display by the browser to notify the user that the website has passed the phishing test and, therefore, the user is good to proceed to log in to the website (e.g., by re-entering the user's login credential).

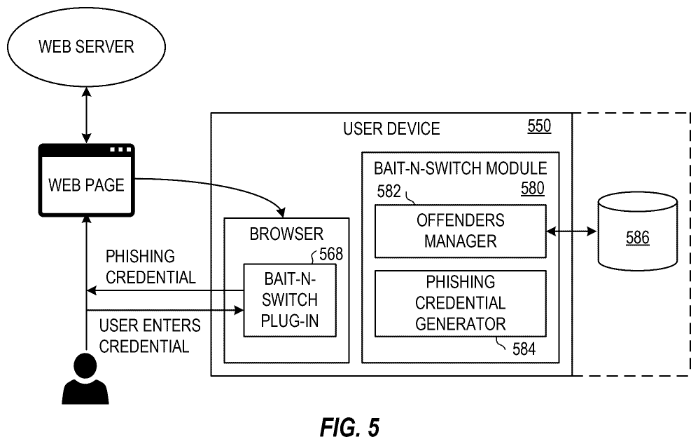

FIG. 5 illustrates another embodiment of a client-side Bait-n-Switch module 580 that works with a Bait-n-Switch plug-in 568 on a user device 550. In this example, the client-side Bait-n-Switch module 580 has an offenders manager 582 and a phishing credential generator 584. The Bait-n-Switch plug-in 568 may operate similar to the Bait-n-Switch plug-in 468 described above. The offenders manager 582 may operate similar to the offenders manager 482 described above. The phishing credential generator 584 may operate similar to the phishing credential generator 484 described above. However, the client-side Bait-n-Switch module 580 may not keep track of good websites or bad websites internally (i.e., no internal databases). Instead, the client-side Bait-n-Switch module 580 may leverage database(s) 586 which can be external to the client-side Bait-n-Switch module and which may or may not be external to the user device 550.

For example, an application (e.g., a browser, a database system, etc.) on the user device 550 may already collect phishing URLs (i.e., offenders) and/or user-domain registration information and store the offenders information and/or the registration information in database(s) 586 on the user device 550. Once the client-side Bait-n-Switch module 580 establishes a trusted relationship with the application, the client-side Bait-n-Switch module 580 may perform lookup operations over the database(s) 586 without needing to separately maintain internal databases.

As another example, an application delivered to the user device 550 as a service provided by a network server operating in a cloud computing environment may aggregate phishing URLs and/or user-domain registration information from multiple client-side Bait-n-Switch modules operating on a plurality of user devices and centrally store the offenders information and/or the registration information in database(s) 586 on a database server. The Bait-n-Switch module 580 may perform lookup operations over the database(s) 586 on the database server without needing to separately maintain internal databases.

In some embodiments, a more comprehensive anti-phishing solution may include an Internet protection system that incorporates features including, but are not limited to:
the ability to identify if a user has entered an authenticating credential (i.e., a user ID and password) in a new web page;
the ability to notify the user of a new website and the intention to perform a Bait-n-Switch maneuver such as the anti-phishing operation described above;
the ability to block the website upon acceptance of a dummy credential randomly selected from a random number of dummy credentials generated based on the user's actual login credential;
the ability to notify the user, upon rejection of the dummy credential, that the web page is likely genuine since it survived the Bait-n-Switch maneuver and that the user is safe to re-enter their actual login credential;
the ability to maintain an encrypted database of authenticating credentials on the client infrastructure with permission, including providing the user with the option to register existing or new credentials, or to delete a registration; and
the ability to maintain a verified URL database to avoid performing the Bait-n-Switch maneuver on already verified URLs. In some cases, URLs may be removed (e.g., periodically or on demand) from the verified URL database manually by an authorized user (e.g., an administrator) or programmatically based on user activity (or the lack thereof), a predetermined time limit, etc.

The embodiments of a client-side anti-phishing solution described above may not capture all the possible phishing websites. However, with the client-side anti-phishing solution described above, the number of false-positives (i.e., phishing websites that are no longer active, unknown websites that are actually not phishing websites, etc.) can be quickly and significantly reduced. This is because, traditionally, determining whether an unknown website is a phishing website relies on some kind of LLM or ML model that can take months (e.g., six months to a year) to build, test (e.g., using a cloud-sourced database and having a large number of users to label correct/incorrect data elements), and deploy. Given the amount of web pages on the Internet and the speed by which phishing techniques are updated and by which phishing websites are abandoned/created, by the time a ML model is deployed, many users may already fall victim to phishing websites that are no longer active. To this end, the client-side anti-phishing solution disclosed herein can, before a user gives up their login credential, as a web page is loading, quickly determines whether the web page comes from a malicious website or a benign website, providing a one-step mitigation against a phishing website's ploy to procure user credentials. Advantageously, the invention can augment other anti-phishing techniques, including those such as classifier ML models employed by current Internet security systems.

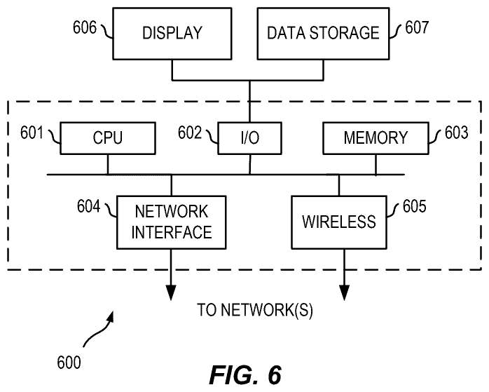

FIG. 6 depicts a diagrammatic representation of a data processing system for implementing a method disclosed herein. As shown in FIG. 6, data processing system 600 may include one or more central processing units (CPU) or processors 601 coupled to one or more user input/output (I/O) devices 602 and memory devices 603. Examples of I/O devices 602 may include, but are not limited to, keyboards, displays, monitors, touch screens, printers, electronic pointing devices such as mice, trackballs, styluses, touch pads, or the like.

Examples of memory devices 603 may include, but are not limited to, hard drives (HDs), magnetic disk drives, optical disk drives, magnetic cassettes, tape drives, flash memory cards, random access memories (RAMs), read-only memories (ROMs), smart cards, etc. Data processing system 600 can be coupled to display 606, information device 607 and various peripheral devices (not shown), such as printers, plotters, speakers, etc. through I/O devices 602. Data processing system 600 may also be coupled to external computers or other devices through network interface 604, wireless transceiver 605, or other means that is coupled to a network such as a local area network (LAN), wide area network (WAN), or the Internet.

Those skilled in the relevant art will appreciate that the invention can be implemented or practiced with other computer system configurations, including without limitation multi-processor systems, network devices, mini-computers, mainframe computers, data processors, and the like. The invention can be embodied in a computer or data processor that is specifically programmed, configured, or constructed to perform the functions described in detail herein.

Embodiments discussed herein can be implemented in suitable instructions that may reside on a non-transitory computer readable medium, hardware circuitry or the like, or any combination and that may be translatable by one or more server machines. Examples of a non-transitory computer readable medium are provided below in this disclosure.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code any of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. The functions of the invention can be achieved in many ways. For example, distributed or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any hardware system, mechanism or component that processes data, signals or other information. A processor can include a system with a central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein, the meaning of “in” includes “in” and “on” unless the context clearly dictates otherwise.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted. The scope of the invention should be determined by the following claims and their legal equivalents.

What is claimed is:

1. An apparatus, comprising:
a processor;
a non-transitory computer-readable medium; and
instructions stored on the non-transitory computer-readable medium and translatable by the processor for implementing an anti-phishing browser plug-in and an anti-phishing module for:
initiating an anti-phishing operation on the apparatus as a user enters a login credential on a web page originating from a website, the anti-phishing operation comprising:
generating a random number of phishing credentials based on the login credential;
randomly selecting, from the random number of phishing credentials, a phishing credential; and
causing a browser application on the apparatus to submit the phishing credential to the website on behalf of the user; and
depending upon whether the phishing credential is accepted by the website, blocking or allowing access to the website.

2. The apparatus of claim 1, wherein the instructions are further translatable by the processor for:
receiving an indication that the user is entering the login credential on the web page;
capturing user input including the login credential being entered on the webpage; and
determining whether the web page comes from a good website, a bad website, or an unknown website.

3. The apparatus of claim 2, wherein the web page resides at a universal resource locator (URL), wherein the determining comprises performing a lookup operation on the URL over an offenders database, and wherein the offenders database stores a plurality of URLs, each respective URL of the plurality of URLs having a phishing status indicative of whether the respective URL is a good URL, a phishing URL, or a new URL.

4. The apparatus of claim 3, wherein the instructions are further translatable by the processor for:
responsive to not finding the URL of the web page in the offenders database, parsing the user input to obtain the login credential;
performing a lookup operation on the login credential over a registration database; and
responsive to finding the login credential in the registration database, setting a phishing status to indicate that the URL of the web page comes from a new website and setting a credential status to indicate that the login credential is true, wherein the initiating is performed responsive to the phishing status being set to new and the credential status being set to true.

5. The apparatus of claim 4, wherein the instructions are further translatable by the processor for:
updating the offenders database to reflect whether the website passed or failed the anti-phishing operation.

6. The apparatus of claim 1, wherein the instructions are further translatable by the processor for:
responsive to the phishing credential being accepted by the website, generating a message indicating that the website has failed the phishing operation and, therefore, access to the website is to be blocked.

7. The apparatus of claim 1, wherein the instructions are further translatable by the processor for:
responsive to the phishing credential being rejected by the website, generating a message indicating that the website has passed the phishing operation and, therefore, access to the website is allowed.

8. A method, comprising:
initiating, by an anti-phishing module on a user device, an anti-phishing operation as a user enters a login credential on a web page originating from a website, the anti-phishing operation comprising:
generating a random number of phishing credentials based on the login credential;
randomly selecting, from the random number of phishing credentials, a phishing credential; and
causing a browser application on the user device to submit the phishing credential to the website on behalf of the user; and
depending upon whether the phishing credential is accepted by the website, blocking or allowing access to the website.

9. The method according to claim 8, further comprising:
receiving an indication that the user is entering the login credential on the web page;
capturing user input including the login credential being entered on the webpage; and
determining whether the web page comes from a good website, a bad website, or an unknown website.

10. The method according to claim 9, wherein the web page resides at a universal resource locator (URL), wherein the determining comprises performing a lookup operation on the URL over an offenders database, and wherein the offenders database stores a plurality of URLs, each respective URL of the plurality of URLs having a phishing status indicative of whether the respective URL is a good URL, a phishing URL, or a new URL.

11. The method according to claim 10, further comprising
responsive to not finding the URL of the web page in the offenders database, parsing the user input to obtain the login credential;
performing a lookup operation on the login credential over a registration database; and
responsive to finding the login credential in the registration database, setting a phishing status to indicate that the URL of the web page comes from a new website and setting a credential status to indicate that the login credential is true, wherein the initiating is performed responsive to the phishing status being set to new and the credential status being set to true.

12. The method according to claim 11, further comprising:
updating the offenders database to reflect whether the website passed or failed the anti-phishing operation.

13. The method according to claim 8, further comprising:
responsive to the phishing credential being accepted by the website, generating a message indicating that the website has failed the phishing operation and, therefore, access to the website is to be blocked.

14. The method according to claim 8, further comprising:
responsive to the phishing credential being rejected by the website, generating a message indicating that the website has passed the phishing operation and, therefore, access to the website is allowed.

15. A computer program product comprising a non-transitory computer-readable medium storing instructions translatable by a processor for implementing an anti-phishing browser plug-in and an anti-phishing module on a user device for:
initiating an anti-phishing operation on the user device as a user enters a login credential on a web page originating from a website, the anti-phishing operation comprising:
generating a random number of phishing credentials based on the login credential;
randomly selecting, from the random number of phishing credentials, a phishing credential; and
causing a browser application on the user device to submit the phishing credential to the website on behalf of the user; and
depending upon whether the phishing credential is accepted by the website, blocking or allowing access to the website.

16. The computer program product claim 15, wherein the instructions are further translatable by the processor for:
receiving an indication that the user is entering the login credential on the web page;
capturing user input including the login credential being entered on the webpage; and
determining whether the web page comes from a good website, a bad website, or an unknown website.

17. The computer program product claim 16, wherein the web page resides at a universal resource locator (URL), wherein the determining comprises performing a lookup operation on the URL over an offenders database, and wherein the offenders database stores a plurality of URLs, each respective URL of the plurality of URLs having a phishing status indicative of whether the respective URL is a good URL, a phishing URL, or a new URL.

18. The computer program product claim 17, wherein the instructions are further translatable by the processor for:
responsive to not finding the URL of the web page in the offenders database, parsing the user input to obtain the login credential;
performing a lookup operation on the login credential over a registration database; and
responsive to finding the login credential in the registration database, setting a phishing status to indicate that the URL of the web page comes from a new website and setting a credential status to indicate that the login credential is true, wherein the initiating is performed responsive to the phishing status being set to new and the credential status being set to true.

19. The computer program product claim 18, wherein the instructions are further translatable by the processor for:
updating the offenders database to reflect whether the website passed or failed the anti-phishing operation.

20. The computer program product claim 15, wherein the instructions are further translatable by the processor for:
responsive to the phishing credential being accepted by the website, generating a message indicating that the website has failed the phishing operation and, therefore, access to the website is to be blocked; and
responsive to the phishing credential being rejected by the website, generating a message indicating that the website has passed the phishing operation and, therefore, access to the website is allowed.
